(19) United States
(12) Patent Application Publication
(10) Pub. No.: US 2015/0271904 A1
(43) Pub. Date: Sep. 24, 2015

(54) X-RAY DEVICE WITH A CONTROL UNIT AND METHOD FOR CONTROLLING ENERGY CONSUMPTION

(71) Applicant: Siemens Aktiengesellschaft, Munich (DE)

(72) Inventors: Winrich HEIDINGER, Erlangen (DE); Sebastian WOLF, Forchheim (DE)

(21) Appl. No.: 14/637,712

(22) Filed: Mar. 4, 2015

(30) Foreign Application Priority Data
Mar. 19, 2014 (DE) 102014205119.3

(51) Int. Cl. H05G 1/32; H05G 1/54

(52) U.S. Cl. CPC H05G 1/32; H05G 1/54

(57) ABSTRACT

An x-ray device is suitable for recording x-ray images and has a number of electrically-operated system components as well as a central unit for central control of the energy consumption of the system components. The central control unit is designed to release the system components of at least one first group as a function of an operating state of at least one system component for a switch into a sleep mode of reduced energy. The released system components are further designed for local control of their own energy consumption, especially for a switch into the sleep mode, as a function of their own operating state. Through control, the energy consumption of the x-ray device is reduced. Furthermore the energy consumption can be flexibly adapted to different usage situations by the local control as a function of the respective operating state of a system component.

### PRIORITY STATEMENT

The present application hereby claims priority under 35 U.S.C. §119 to German patent application number DE 102014205119.3 filed Mar. 19, 2014, the entire contents of which are hereby incorporated herein by reference.

### FIELD

At least one embodiment of the invention is directed to an X-ray device with a control unit and/or a method for controlling energy consumption.

### BACKGROUND

X-ray devices for recording x-ray images are used in a plurality of technical areas, for example for material testing, baggage checking and medical imaging. Such x-ray devices have a plurality of electrically-operated system components such as an x-ray source or an x-ray detector. In such cases especially high voltages are required for operating an x-ray source. Furthermore system components such as the x-ray source must be cooled. Technically especially high demands are imposed on x-ray devices for three-dimensional imaging, which have a rotatable recording unit. Such a rotatable recording unit is embodied as part of a gantry and is generally likewise electrically operated.

These circumstances result in a high power consumption of x-ray devices, especially of x-ray devices for three-dimensional imaging. Even in phases in which no x-ray recording is taking place, the x-ray device is often left in the active mode by the user. A reason for this can be that a computer connected to the x-ray device is used for reconstruction, presentation and further processing of the x-ray images. Thus for example in the clinical environment a computer connected to the x-ray device is regularly used for diagnosis. Furthermore it can be the wish of the user that the x-ray device is ready at all times to record x-ray images again.

No solutions are yet known for x-ray devices which control the energy consumption and especially the power consumption in an intelligent manner. The energy consumption of an x-ray device has previously been controlled centrally for the entire x-ray device. In such cases the requirements for controlling the energy consumption differ depending on the usage situation of the x-ray device. Thus the requirements in emergency medicine are often different from those in cardiological practice. Also the loads on the individual system components can differ greatly depending on patient and recording protocol, which increases the desire for a further flexibilization of the control of the energy consumption.

A proposal for adapting the control of the energy consumption of an x-ray device to changing clinical working sequences is known from publication US 2012/0033783 A1. In this document a computed tomograph with a gantry, an x-ray tube, an x-ray detector and a patient couch and a console is described, wherein the computed tomograph also has a memory unit, a power supply unit and a corresponding control unit. The memory unit stores examination plans for the computed tomograph. The power supply unit can be operated selectively in an active mode and in a standby mode and switches between the two modes as a function of the examination plan. In such cases in active mode at least the gantry or the patient couch or the console are supplied with power. In standby mode at least the gantry or the patient couch or the console are supplied with less power than in active mode. Furthermore the switch between the two modes can be dependent on the temperature of the gantry. In each case the switch between the two modes is controlled centrally via the control unit.

### SUMMARY

An embodiment of the present invention is directed to reducing the energy consumption of an x-ray device and at the same time adapting the energy consumption flexibly to different usage situations.

Embodiments of an x-ray device and a method are disclosed.

Features, advantages or alternate forms of embodiment mentioned here are likewise to be transferred to the other claimed subject matter and vice versa. In other words the physical claims (which are directed to the x-ray device for example) can also be further developed with the features which are described or claimed in conjunction with a method. The corresponding functional features of the method in such cases are embodied by corresponding physical modules.

An embodiment of an inventive x-ray device is suitable for recording x-ray images and has a number of electrically-operated system components as well as a central control unit for central control of the energy consumption of the system components. The central control unit is designed to release the system components of at least a first group as a function of an operating state of at least one system component for a switch into a sleep mode of reduced energy consumption. The released system components are also designed for local control of their own energy consumption, especially for a switch into sleep mode, as a function of their own operating state. Through an embodiment of the inventive control, the energy consumption of the x-ray device is reduced. Furthermore the energy consumption, by local control as a function of the respective operating state of a system component, can be adapted flexibly to different usage situations.

In accordance with a further aspect of an embodiment of the invention, the x-ray device has as its system components at least one x-ray source, an x-ray detector interacting with the x-ray source, a movable patient couch, and also a processing unit for controlling the x-ray device.

In accordance with a further aspect of an embodiment, the x-ray device includes a display unit for displaying the energy consumed by the x-ray device and/or for displaying the energy saved by the sleep mode or by the sleep modes. This gives the user of the x-ray device rapid and technically easy-to-realize feedback about the saved energy.

Furthermore, an embodiment is directed to a method, performable on a computer for example. The computer includes a memory for storage of computer programs and also a processor for executing the stored computer programs. The computer program for executing the method steps of an embodiment of the inventive method includes program code. In the forms of embodiment shown here at least one computer program is stored in the memory which executes steps of an embodiment of the inventive method when the computer program is executed on the computer. Furthermore the computer program can be retrievably stored on a computer program product in the form of a machine-readable medium. The machine-readable medium can especially involve a CD, DVD, Blu-Ray disc, a memory stick or a hard disk.

### BRIEF DESCRIPTION OF THE DRAWINGS

The invention is described and explained in greater detail below on the basis of the example embodiments shown in the figures.

In the figures:

FIG. 1 shows an embodiment of an inventive x-ray device in the form of a computed tomograph,

FIG. 2 shows an inventive x-ray device in the form of a C-arm x-ray device,

FIG. 3 shows a flow diagram of an embodiment of the inventive method,

FIG. 4 shows a first schematic diagram of the units for controlling energy consumption,

FIG. 5 shows a second schematic diagram of the units for controlling energy consumption,

FIG. 6 shows a schematic diagram of switching into a hierarchical sequence of sleep modes.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An embodiment of an inventive x-ray device is suitable for recording x-ray images and has a number of electrically-operated system components as well as a central control unit for central control of the energy consumption of the system components. The central control unit is designed to release the system components of at least a first group as a function of an operating state of at least one system component for a switch into a sleep mode of reduced energy consumption. The released system components are also designed for local control of their own energy consumption, especially for a switch into sleep mode, as a function of their own operating state. Through an embodiment of the inventive control, the energy consumption of the x-ray device is reduced. Furthermore the energy consumption, by local control as a function of the respective operating state of a system component, can be adapted flexibly to different usage situations.

In accordance with a further aspect of an embodiment of the invention, the released system components, for local control of their own energy consumption, are each designed independently of other system components, through which the flexibility for controlling the energy consumption of the x-ray device is further enhanced.

In accordance with a further aspect of an embodiment of the invention, the released system components are designed for local control of their own energy consumption for a switch into a plurality of sleep modes. This makes possible a graduated and differentiated control of the energy consumption and an even more flexible adaptation of the energy consumption to different usage situations.

In accordance with a further aspect of an embodiment of the invention, the released system components, for local control of their own energy consumption, are designed for a switch according to a defined hierarchical sequence of sleep modes. This prevents abrupt switches in the energy supply of individual system components, so that the safety and reliability of the invention is increased. This applies in particular when the system components, in a subsequent sleep mode in each case, have a lower energy consumption than in the preceding mode.

In accordance with a further aspect of an embodiment of the invention, the x-ray device has as its system components at least one x-ray source, an x-ray detector interacting with the x-ray source, a movable patient couch, and also a processing unit for controlling the x-ray device.

In accordance with a further aspect of an embodiment of the invention, the central control unit is designed to release the system components of at least one first group as a function of at least the following operating states for a switch into sleep mode or one of the sleep modes:
A temperature of at least a part of a system component,
A position and/or a change of the position of at least a part of a system component,
An inactive period of time of a system component.

In accordance with a further aspect of an embodiment of the invention, the central control unit is designed to release the system components of at least the first group as a function of a usage profile of the x-ray device for a switch into sleep mode or one of the sleep modes. The usage profile takes account of typical usage situations for the respective x-ray device, so that the control of the energy consumption is adapted especially flexibly to the usage situations.

In accordance with a further aspect of an embodiment, the x-ray device includes a display unit for displaying the energy consumed by the x-ray device and/or for displaying the energy saved by the sleep mode or by the sleep modes. This gives the user of the x-ray device rapid and technically easy-to-realize feedback about the saved energy.

In accordance with a further aspect of an embodiment of the invention, the central control unit is designed to release the system components of at least the first group as a function of an operating state of at least one system component for a switch from the sleep mode or one of the sleep modes into the active mode, wherein the released system components are designed for local control of their own energy consumption, especially for a switch into the active mode, as a function of their own operating state.

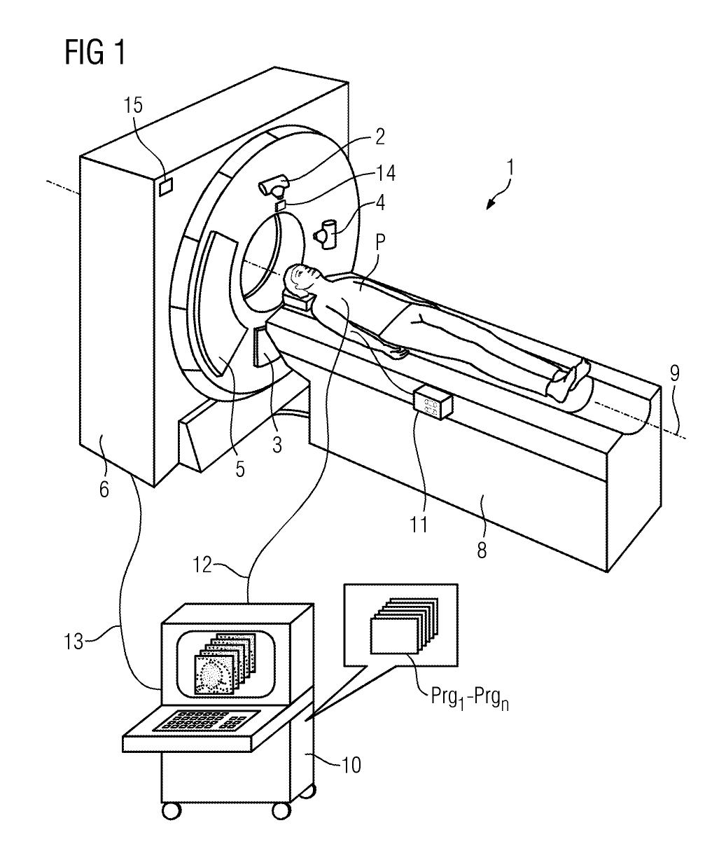

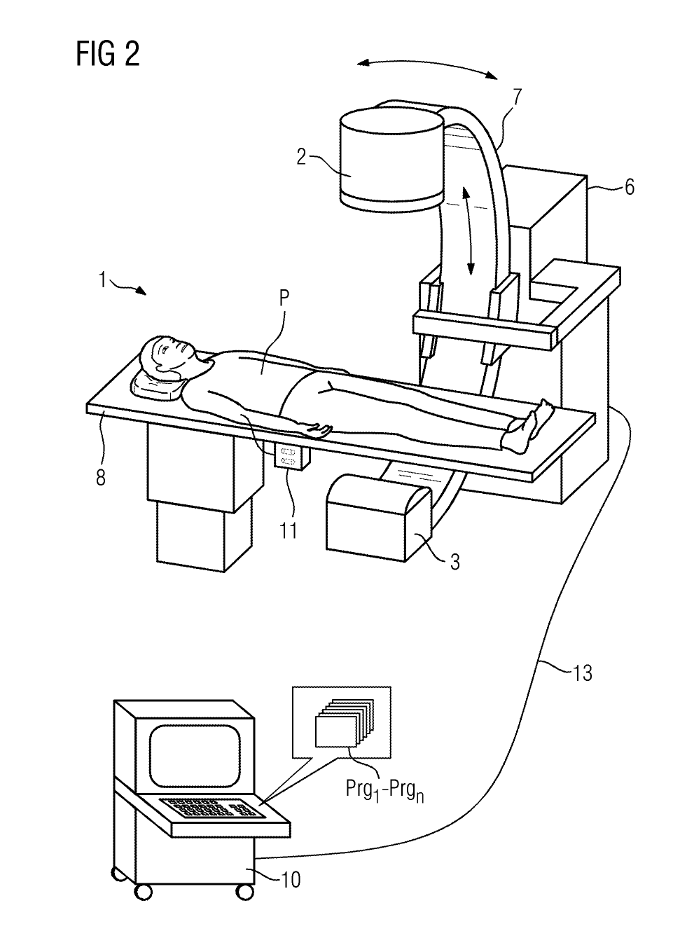

FIG. 1 and FIG. 2 each show an embodiment of an inventive x-ray device 1 for recording x-ray images. The examples shown here each involve x-ray devices 1, which are designed for recording three-dimensional x-ray images, especially for recording tomographic x-ray images. The recording of x-ray images includes the step of recording measurement data which is also referred to as raw data. The measurement data involves x-ray projections of an examination object. X-ray images, especially three-dimensional x-ray images, can then be reconstructed from the measurement data. But also the recording of x-ray projections without further reconstruction, as is usual in fluoroscopy, is intended to represent a recording of x-ray images in the sense of this application.

An embodiment of an inventive x-ray device 1 has a number of system components SK_1 . . . SK_N. A system component SK_1 . . . SK_N involves an electrically-operated component of the x-ray device 1, wherein the system component SK_1 . . . SK_N is intended for planning or carrying out a recording of measurement data or for reconstruction of x-ray images from measurement data and for further processing of x-ray images. For example the system components SK_1 . . . SK_N can involve an x-ray source 2, 4, an x-ray detector 3, a movable patient table 8, a contrast medium injector 11, the drive of a gantry 6, a positioning laser 14 or a computer 10. Furthermore a system component SK_1 . . . SK_N can involve a camera, especially for detection of light in the visible spectrum and/or a camera for detection of depth information. Such a camera can be employed for example for positioning the examination object or for control of the x-ray device 1 by way of gesture recognition.

In the examples shown here a patient P lies as an examination object on a patient couch 8. The patient couch 8 is designed to move the patient P during a recording of measurement data along a system axis 9. During the recording of measurement data an x-ray source 2 and an x-ray detector 3, 5 interacting with the x-ray source 2, 4 move around a system axis 9. The measurement data in the examples shown here involves a plurality of projections of a part of the body of the patient P, wherein the projections each specify the attenuation of the x-ray radiation by the part of the body of the patient P.

In the example embodiment shown in FIG. 1 with a computed tomograph the x-ray detectors 3, 5 have a number of rows and columns, while the C-arm x-ray device shown in FIG. 2 has an x-ray detector 3, 5 in the form of a flat-panel detector. The x-ray detectors 3, 5 can be embodied both as scintillator counters and also as direct-converting x-ray detectors. They can furthermore be embodied as counting x-ray detectors, which are designed to detect and count individual photons. Furthermore the computed tomograph in the example shown in FIG. 1 has two pairs of x-ray sources 2, 4 interacting with one another in the form of x-ray tubes and x-ray detectors 3, 5. This makes the computed tomograph shown here especially suited to multi-energy recordings in which the two x-ray tubes emit x-ray radiation with a different energy spectrum. In further forms of embodiment not shown here the computed tomograph only has one x-ray source 2, 4 and one x-ray detector 3, 5 in each case.

In the C-arm x-ray device shown in FIG. 2 the x-ray source 2, 4 and the x-ray detector 3, 4 are connected by a C-arm 7, which in its turn is fastened to a gantry 6. The gantry 6 of the computed tomograph can be embodied so that it is able to be tilted around at least one axis at right angles to the system axis 9. The C-arm 7 of the C-arm x-ray device shown in FIG. 2 is able to be hinged or rotated in each case along the two arrows.

In addition the x-ray devices 1 shown here also each have a contrast medium injector 11 for injection of contrast medium into the blood circulation of the patient P. This enables the measurement data to be recorded by way of a contrast medium such that for example the vessels of the patient P, especially the heart chambers of the beating heart, can be presented with an enhanced contrast. Furthermore the inventive x-ray device 1 can have a positioning laser 14 or another means of illumination for positioning the examination object, especially a patient P. In the example shown in FIG. 1 the positioning laser 14 is integrated into the gantry 6 of the computed tomograph. Furthermore the inventive x-ray device 1 can have a display unit 15 for graphical display of the consumed and/or saved energy compared to continuous operation in active mode, for example in units of kWh. Furthermore the display can specify the saved CO2 amount. In such cases both numbers and also symbols can be shown. The consumed and/or saved energy or CO2 amount can be calculated for example by a program stored on the computer 10.

Furthermore an embodiment of an inventive x-ray device 1 includes a central control unit ZKE for central control of the energy consumption of the system components SK_1 . . . SK_N. Such a central control unit ZKE can be realized both in the form of hardware and also in the form of software. In the examples shown here the central control unit is realized as a program with the program code Prg1-Prgn which is stored on the computer 10, which is also referred to as a workstation. Furthermore the computer 10 can be designed in general to control the x-ray device 1, i.e. to start a series of recordings or abort a recording. Furthermore the computer 10, in the form of embodiment shown in FIG. 1, is designed to receive and to process EKG signals of the patient P by way of an EKG data connection 12.

The computer 10 is connected to an output unit and also to an input unit. The output unit involves for example one (or more) LCD, plasma or OLED screens. The output on the output unit includes for example a graphical user interface or the output of x-ray images. The input unit is designed for input of data such as patient data for example and also for input and selection of parameters for the use of the x-ray device 1, in particular for the use of the central control unit ZKE. The input unit involves a keyboard, a mouse, a touchscreen or also a microphone for voice input for example.

In the examples shown here the computer 10 is further designed to receive the measurement data via a data connection 13 from the computed tomograph or from the C-arm x-ray device and to reconstruct x-ray images from the measurement data via a reconstruction unit. In an alternate form of embodiment of the invention the computer 10 is connected to a processing system in the form of a reconstruction processor, to which the measurement data can be copied through a further data connection, so that the processor system can reconstruct x-ray images from the measurement data via a reconstruction unit. The reconstruction unit can be embodied both as hardware and also as software.

Furthermore the computer 10 includes a memory for storage of computer programs and also a processor for executing the stored computer programs. The computer program for executing the method steps of an embodiment of the inventive method includes program code Prg1-Prgn. In the forms of embodiment shown here at least one computer program is stored in the memory which executes steps of an embodiment of the inventive method when the computer program is executed on the computer 10. Furthermore the computer program can be retrievably stored on a computer program product in the form of a machine-readable medium. The machine-readable medium can especially involve a CD, DVD, Blu-Ray disc, a memory stick or a hard disk.

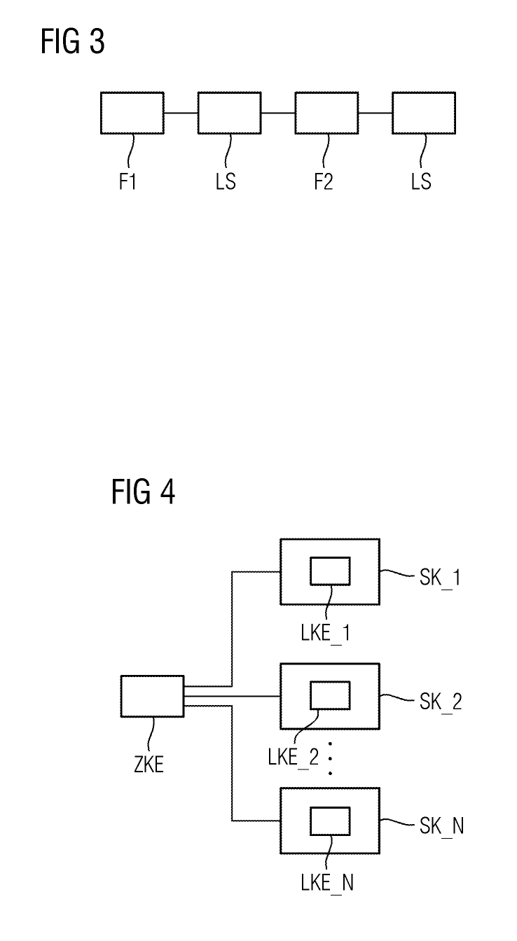

FIG. 3 shows a flow diagram of an embodiment of the inventive method. In accordance with an embodiment of the invention, the central control unit ZKE is designed for the central control of the energy consumption of the system components SK_1 . . . SK_N and does this by the functionality of a first central release F1 of at least a first group GR_1 . . . GR_M of system components SK_1 . . . SK_N for a switch into a sleep mode SM_1 . . . SM_L. A sleep mode SM_1 . . . SM_L involves a mode of reduced energy consumption by comparison with the active mode AM. In active mode AM the respective system components SK_1 . . . SK_N are ready for their specified use. In other words the response time of the system components SK_1 . . . SK_N in active mode AM is short, so that said components can be employed very quickly. Such a use can for example consist of the emission of x-ray radiation, the rotation of the recording unit or the movement of the patient couch. The reduced energy consumption in a sleep mode SM_1 . . . SM_L by contrast is accompanied by a longer response time of the system components SK_1 . . . SK_N, so that said components cannot be used as quickly as they can be in active mode AM.

Furthermore first central release F1 takes place as a function of an operating state of at least one system component SK_1 . . . SK_N. The central control unit ZKE is thus designed to detect and to process the operating state of the system components SK_1 . . . SK_N. For example the system components SK_1 . . . SK_N or at least a part of the system components SK_1 . . . SK_N can regularly send an operating state signal to the central control unit ZKE. Such an operating state signal can be sent for example via a data connection 13. Furthermore the operating state signal can be sent as a reaction to a request for the operating state by the central control unit ZKE. The request for the operating state can especially include the sending of a request signal from the central control unit ZKE to the system components SK_1 . . . SK_N or at least to a part of the system components SK_1 . . . SK_N.

The operating state generally involves a quantifiable value, which is a measure for the activity of a system component SK_1 . . . SK_N. For example the operating state can involve an inactive period of time of a system component SK_1 . . . SK_N, i.e. the period in which a system component SK_1 . . . SK_N is not being used or has not been activated; the inactive period can especially relate to a period of time in which the system component SK_1 . . . SK_N is in the active mode. Furthermore the operating state can involve a position and/or a change of the position of at least one part of a system component SK_1 . . . SK_N. If a patient table 8 is moved into a certain area and parked in this area for a specific time, then this can show by the operating state characterizing the change of position as well as the absolute position that in the near future there is an increased probability of the x-ray device 1 not being used. A further example for an operating state is the temperature of at least one part of a system component SK_1 . . . SK_N. In particular the temperature of the x-ray source 2, 4 is a measure for the activity of the x-ray source 2, 4 and thus also a measure for the probability of the use of the x-ray device 1, especially for recording an x-ray image.

The first central release F1 only occurs when a criterion relating to the operating state is fulfilled. The criterion can involve a defined threshold value being exceeded or not being reached. The logical regulation of whether the criterion is fulfilled can be undertaken depending on the form of embodiment by the system component SK_1 . . . SK_N itself or by the central control unit ZKE. The first central release F1 ultimately occurs by a release signal being sent by the central control unit ZKE to the system component SK_1 . . . SK_N of at least the first group GR_1 . . . GR_M. The first central release F1 does not lead directly to a switch into a sleep mode SM_1 . . . SM_L, but causes local control LS of the respective system component SK_1 . . . SK_N, for example by a program for local control being started. Furthermore the method can also include further central releases, for example individual sleep modes SM_1 . . . SM_L can be released individually. In particular the sleep modes SM_1 . . . SM_L can be released in a defined hierarchical sequence.

Local control LS relates to the control of the energy consumption at local level, i.e. at the level of an individual system component SK_1 . . . SK_N by the respective system component SK_1 . . . SK_N itself. Local control LS can thus include a number of local control processes, wherein a specific control process relates to an individual system component SK_1 . . . SK_N. Such local control LS offers the advantage that it is undertaken as a function of the operating state of the respective system component SK_1 . . . SK_N and thus—unlike purely central control—allows flexible adaptation of the control of the energy consumption to very different usage situations. The usage situation encompasses the circumstances of the usage of the x-ray device 1, especially the embedding of the usage into a working sequence. The local control LS can be designed for example such that specific system components SK_1 . . . SK_N after a very short inactive time are put into a sleep mode SM_1 . . . SM_L, since they are typically frequently used, while other system components SK_1 . . . SK_N are put into a sleep mode SM_1 . . . SM_L after a longer inactive time since they are typically less frequently used. Furthermore the individual local control processes can also distinguish as a function of this how great the wake-up time of the controlled system component SK_1 . . . SK_N is. The wake-up time is the time which is needed for a switch from a specific sleep mode SM_1 . . . SM_L into the active mode AM.

Furthermore, an embodiment of the proposed invention is especially flexible when the local control processes of the individual system components SK_1 . . . SK_N execute independently of one another in each case. In particular the released system components SK_1 . . . SK_N can be designed for local control of the time of the switch into sleep mode SM_1 . . . SM_L independent of other system components SK_1 . . . SK_N.

In specific variants of the invention, however, a coupling exists between the local control of different system components SK_1 . . . SK_N so that a coupling also exists between individual local control processes. Such a coupling means, in other words, that the local control of the energy consumption of a system component SK_1 . . . SK_N is undertaken both as a function of the own operating state and also as a function of the operating state of a further system component SK_1 . . . SK_N. In one form of embodiment the switch of the x-ray source 2, 4 into the sleep mode SM_1 . . . SM_L is only undertaken after the x-ray source 2, 4 has received a corresponding signal from the patient table 8 that the patient table 8 has already completed the switch into sleep mode SM_1 . . . SM_L. Furthermore only the system components SK_1 . . . SK_N—and thus the corresponding local control processes—which are assigned to the same group GR_1 . . . GR_M can be coupled to one another.

In accordance with a further aspect of an embodiment of the invention, a second central release F2 of system components SK_1 . . . SK_N of at least one group GR_1 . . . GR_M from a sleep mode SM_1 . . . SM_L into an active mode AM is undertaken by way of the central control unit ZKE. The second central release F2 is also undertaken as a function of an operating state of a system component SK_1 . . . SK_N. If for example the patient table 8 and/or the positioning laser 14 are used for positioning, the second central release F2 can take place.

FIG. 4 shows a first schematic diagram of the units for control of energy consumption. In addition to the central control unit ZKE, local control units LKE_1 . . . LKE_N are shown, which are each embodied as an element of a system component SK_1 . . . SK_N. In the example shown here each system component SK_1 . . . SK_N has precisely one control unit LKE_1 . . . LKE_N, but in further forms of embodiment a system component SK_1 . . . SK_N can also have a number of control units LKE_1 . . . LKE_N. The local control units LKE_1 . . . LKE_N are each designed to perform a local control process for local control of the energy consumption. The local control units LKE_1 . . . LKE_N are further designed to send local control signals to the central control unit ZKE and to receive release signals for first or second central release from the central control unit ZKE. Like the central control unit ZKE the local control units LKE_1 . . . LKE_N can be embodied both as hardware and also as software.

Furthermore both a central control unit ZKE realized as a program and also local control units LKE_1 . . . LKE_N realized as programs can be embodied for the central releases F1, F2 or for local control LS as a function of learned usage patterns. A usage pattern involves typical switches between different usage situations. Thus the typical work sequence can differ greatly in different working environments, for example in relation to the pauses between individual recordings of x-ray images or in relation to the recording protocols. The learning of the usage pattern can especially be undertaken by machine learning. Through an embodiment of this, the inventive x-ray device 1 and also an embodiment of the inventive method are designed even more flexibly and in a more user-friendly manner. In a further variant it is naturally also conceivable for specific criteria such as the inactive time before the first central release F1 or a switch into a sleep mode SM_1 . . . SM_L by the user, by manual input for example, to be prespecified.

FIG. 5 shows a second schematic diagram of the units for controlling energy consumption. In the example shown here specific groups GR_1 . . . GR_M of system components SK_1 . . . SK_N are released. The system components SK_1 . . . SK_N can be assembled on the basis of different criteria into groups GR_1 . . . GR_M. For example all system components SK_1 . . . SK_N, which are accommodated in the gantry 6 can be grouped together. As an alternative the system components SK_1 . . . SK_N can be grouped in accordance with their wake-up time or also according to the switching time from active mode AM into a sleep mode SM_1 . . . SM_L. Furthermore system components SK_1 . . . SK_N of a specific functionality can also be grouped together. For example it can be sensible to assemble such system components SK_1 . . . SK_N as are required for positioning the examination object into a group GR_1 . . . GR_M.

The groups GR_1 . . . GR_M can either all be released at the same or at different points in time for a switch into a mode of reduced or increased energy consumption. With a simultaneous release of different groups GR_1 . . . GR_M it is advantageous for the local control processes of the individual system components SK_1 . . . SK_N within a group GR_1 . . . GR_M not to run completely independently of one another; this is clear from the example of the group GR_1 . . . GR_M of all system components SK_1 . . . SK_N accommodated in the gantry 6. This is because a reduction of the central power for the gantry 6 is not sensible if system components such as the x-ray source 2, 4 not accommodated in the gantry have already powered down for this purpose. Thus the cooling circuit of an x-ray tube should not be switched off until the operating temperature of the x-ray tubes has reached a certain value.

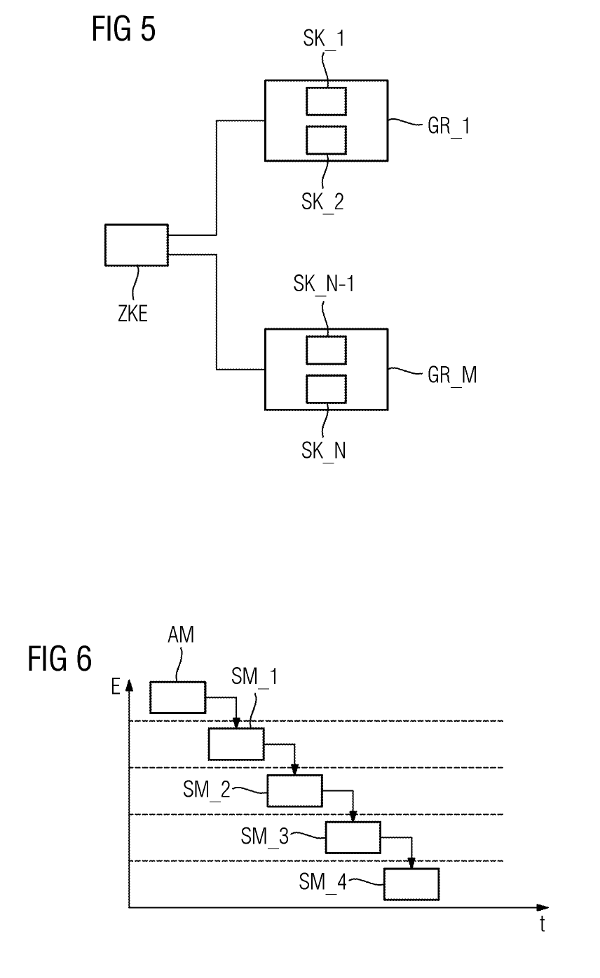

FIG. 6 shows a schematic diagram of switching into a hierarchical sequence of sleep modes. The horizontal axis shows the time t advancing from left to right, while the vertical axis shows the energy consumption E increasing from bottom to top. The presentation can relate for example to the energy consumption of an individual system component SK_1 . . . SK_N. The sleep modes SM_1 . . . SM_4 are hierarchical to the extent that a specific sleep mode must be passed through before the system component SK_1 . . . SK_N can switch to the next sleep mode. Furthermore the sleep modes shown here are hierarchical to the extent that the system component SK_1 . . . SK_N uses less energy in the respective next sleep mode than in the previous sleep mode.

Although the invention has been illustrated and described in greater detail by the preferred example embodiments, the invention is not restricted by the disclosed examples and other variations can be derived herefrom by the person skilled in the art without departing from the scope of protection of the invention. In particular method steps can be performed in a sequence other than that specified.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An x-ray device for recording x-ray images, comprising:
electrically-operated system components; and
a central control unit, for central control of energy consumption of the system components, configured to release the system components of at least one first group as a function of an operating state of at least one system component for a switch into a sleep mode of reduced energy consumption, the released system components being designed for local control of their own energy consumption, as a function of their own operating state.

2. The x-ray device of claim 1, wherein the released system components are designed for local control of their own energy consumption independently of other system components.

3. The x-ray device of claim 1, wherein the released system components are designed for local control of their own energy for a switch into a plurality of sleep modes.

4. The x-ray device of claim 1, wherein the released system components are designed for local control of their own energy consumption for a switch in accordance with a defined, hierarchical sequence of sleep modes.

5. The x-ray device of claim 4, wherein the system components in the respective following sleep mode have a relatively lower energy consumption than in the preceding sleep mode.

6. The x-ray device of claim 1, wherein the system components include at least:
an x-ray source,
an x-ray detector interacting with the x-ray source,
a movable patient couch,
a processing unit for controlling the x-ray device.

7. The x-ray device of claim 1, wherein the central control unit is designed to release the system components of at least the first group as a function of at least the following operating states for a switch into the sleep mode or one of the sleep modes:
a temperature of at least a part of the system component,
at least one of a position and a change in the position of at least a part of a system component,
an inactive period of time of a system component.

8. The x-ray device of claim 1, wherein the central control unit is designed to release the system components at least of the first group as a function of a usage profile of the x-ray device for a switch into the sleep mode or into one of the sleep modes.

9. The x-ray device of claim 1, further comprising:
a display unit to display at least one of the energy consumed by the x-ray device and the energy saved by the sleep mode or by the sleep modes.

10. The x-ray device of claim 1, wherein the central control unit is designed to release the system components of at least the first group as a function of an operating state of at least one system component for a switch from the sleep mode or one of the sleep modes into the active mode, and wherein the released system components are designed for local control of their own energy consumption as a function of their own operating state.

11. A method for controlling the energy consumption of an x-ray device, including a number of electrically operated system components, for recording x-ray images, the method comprising:
centrally releasing the system components of at least a first group as a function of an operating state of at least one system component for a switch into a sleep mode of reduced energy consumption; and
locally controlling the energy consumption of the released system components by the respective released system component itself as a function of its operating state.

12. The method of claim 11, wherein the local control of a system component, of the system components, is undertaken independently of other of the system components.

13. The method of claim 11, further comprising:
locally controlling switching into a plurality of sleep modes.

14. The method of claim 13, wherein the local control of switching is undertaken in accordance with a defined, hierarchical sequence of sleep modes.

15. The method of claim 14, wherein the local control of switching is undertaken such that the system components in the respective following sleep mode have a relatively lower energy consumption than in the preceding sleep mode.

16. The method of claim 11, wherein the first central release for a switch into the sleep mode or into one of the sleep modes of the system components of at least the first group is undertaken as a function of at least the following operating states:
a temperature of at least a part of a system component,
a position of at least a part of a system component,
an inactive period of time of a system component.

17. The method of claim 11, wherein the first central release for a switch into the sleep mode or into one of the sleep modes is undertaken as a function of a usage profile of the x-ray device.

18. The method of claim 11, further comprising:
second central releasing of the system components of at least the first group for a switch from the sleep mode or one of the sleep modes into the active mode as a function of an operating state of at least one system component,
locally controlling of the energy consumption of the released system components by the respective released system components themselves as a function of their operating state.

19. The x-ray device of claim 2, wherein the released system components are designed for local control of their own energy consumption for a switch in accordance with a defined, hierarchical sequence of sleep modes.

20. The x-ray device of claim 19, wherein the system components in the respective following sleep mode have a relatively lower energy consumption than in the preceding sleep mode.

21. The x-ray device of claim 2, wherein the system components include at least:
an x-ray source,
an x-ray detector interacting with the x-ray source,
a movable patient couch,
a processing unit for controlling the x-ray device.

22. The x-ray device of claim 2, wherein the central control unit is designed to release the system components of at least the first group as a function of at least the following operating states for a switch into the sleep mode or one of the sleep modes:
a temperature of at least a part of the system component,
at least one of a position and a change in the position of at least a part of a system component,
an inactive period of time of a system component.

23. The x-ray device of claim 2, wherein the central control unit is designed to release the system components at least of the first group as a function of a usage profile of the x-ray device for a switch into the sleep mode or into one of the sleep modes.

24. The x-ray device of claim 2, further comprising:
a display unit to display at least one of the energy consumed by the x-ray device and the energy saved by the sleep mode or by the sleep modes.

25. The method of claim 12, further comprising:
locally controlling switching into a plurality of sleep modes.

26. The method of claim 25, wherein the local control of switching is undertaken in accordance with a defined, hierarchical sequence of sleep modes.

27. The method of claim 26, wherein the local control of switching is undertaken such that the system components in the respective following sleep mode have a relatively lower energy consumption than in the preceding sleep mode.
